(19) United States
(12) Patent Application Publication
(10) Pub. No.: US 2026/0187578 A1
(43) Pub. Date: Jul. 2, 2026

(54) A METHOD IS PROVIDED OF OPERATING INFORMATION FLOW FOR A PRODUCT WHILE TRANSPORTING THE PRODUCT IN A SUPPLY CHAIN FROM A PRIMARY TRANSPORT LEG TO A LAST-MILE TRANSPORT LEG

(71) Applicant: CONTROLANT HF., Kopavogur (IS)

(72) Inventors: Gisli HERJOLFSSON, Kopavogur (IS); Erlingur BRYNJULFSSON, Kopavogur (IS)

(21) Appl. No.: 19/129,500

(22) PCT Filed: Nov. 16, 2023
(86) PCT No.: PCT/EP2023/082110

§ 371 Date: May 13, 2025

(30) Foreign Application Priority Data
Nov. 18, 2022 (EP) 22208417.0

(51) Int. Cl. G06Q 10/0832; G06Q 10/083; G06Q 10/0833

(52) U.S. Cl. CPC G06Q 10/0832; G06Q 10/0833; G06Q 10/0838

(57) ABSTRACT

A method and a system are for operating information flow for a pharmaceutical product while transporting the pharmaceutical product in a supply chain from a primary transport leg to a last-mile transport leg, where the pharmaceutical product has associated unique identifier (ID) containing plurality of application identifiers identifying different characteristic data related to the pharmaceutical product, the method comprising: scanning the unique ID of the pharmaceutical product, providing location information of the scanning including the country code of scanning, accessing a manufacturing Uniform Resource Locator (URL) portal address related to the pharmaceutical product via scanning the unique ID, wherein the location information is utilized as input data in controlling information flow on the URL portal address.

### FIELD OF THE INVENTION

The present invention relates to a method and a system for preparing a shipment consisting of multiple of shipment units each having associated a wireless logger device.

### BACKGROUND OF THE INVENTION

With the expansion and growth of global sourcing in a supply chain, more prevalent interest has been placed on automatic monitoring of time and of environment related parameters to increase food and drug safety and improve food defense systems throughout all areas of production, processing, storage and transportation and operations. Food and drug require proper handling of environment related parameters such as temperature during transport to assure shelf quality, longevity, and safety.

Logger devices are electronic monitoring devices commonly used for these purposes, namely, to be associated with assets such as food, beverages, or drugs to automatically monitor and record various environmental related parameters of the assets throughout a supply chain, such as temperature, humidity, acceleration, and air pressure, over time. A recent example of importance of such logger devices is the temperature monitoring of the COVID-19 vaccines, which is a key critical monitoring parameter.

The supply chain contains different transport legs, such as a primary transport leg where a primary distribution from manufacturing facility to regional distribution site takes place, a secondary transport leg where secondary distribution from the regional distribution site to e.g., local market distribution takes place, and last mile transport leg where last mile distribution from the regional distribution to pharmacies, hospitals, or directly to patients takes place.

Pharmaceutical products that are transported through such a supply chain commonly, if not always, contain barcodes, and the transport includes scanning a barcode and retrieving information about the package.

Today, the sole information that is shown when such barcodes are scanned is complex shipment order code that only the logistics provider or the manufacture have access to and can see more detailed information.

### SUMMARY OF THE INVENTION

It is an object of the invention to improve visibility of the data when a shipment order code for a product is scanned during the transport throughout the supply chain. The product may be any type of sensitive product such as, but not limited to, a food product, a beverage, or a pharmaceutical product. In the following, it will be assumed that the product is a pharmaceutical product.

In general, the invention preferably seeks to mitigate, alleviate, or eliminate one or more of the above-mentioned disadvantages of the prior art singly or in any combination. In particular, it may be seen as an object of embodiments of the present invention to provide a method and a system that solves the above-mentioned problems, or other problems.

To better address one or more of these concerns, in a first aspect, the invention provides a method of controlling an information flow related to a pharmaceutical product, while transporting the pharmaceutical product in a supply chain from a primary transport leg to a last-mile transport leg.

The pharmaceutical product has an associated unique identifier (unique ID) containing a plurality of application identifiers, wherein each application identifier identifies characteristic data related to the pharmaceutical product.

The method comprises:
scanning the ID of the pharmaceutical product by use of a scanning device,
providing location information identifying a location where the scanning of the unique ID took place,
accessing a manufacturing Uniform Resource Locator (URL) portal address related to the pharmaceutical product for which the unique ID is scanned,
providing the location information to the URL and utilizing the location information at the URL as input data in a process which defines a subset of a data record related to the pharmaceutical product, and
controlling the information flow by providing the subset of the data record via the URL portal address.

Accordingly, the method operates an information flow for a pharmaceutical product while transporting the pharmaceutical product by use of a manufacturing Uniform Resource Locator (URL) portal address related to the pharmaceutical product, and the location information is utilized as input data in controlling the information flow on the URL portal address.

In an embodiment, the location information is provided via an IP address of the scanning device, and/or WiFi location information e.g., where the scanning device is connected to the network, and/or a cellular network cell e.g., through which the scanning device communicates.

In one embodiment, the step of controlling the information flow includes selecting the language of the information flow such that it matches the language associated to the country code of the scanning. In another embodiment, the step of controlling the information flow includes filtering the amount of content being shown on the URL address. The scanning may in one embodiment be performed by a scanning device, such as a mobile device such as a mobile phone or any other portable device or non-portable device.

Accordingly, a highly advanced solution is provided for fully controlling what information is shown on the URL address when a user scans the unique ID. Accordingly, anyone that is not an end-user of the pharmaceutical products, but still scans the unique ID when e.g., placing the pharmaceutical product in a transport truck, does not need to know the details about the shipment containing the pharmaceutical product. Thus, in such a case, the scanning might e.g., result in asking the user if the shipment seems undamaged, where the scanner may then select “Yes”, which during the supply chain transport trigger message that the product has now entered this particular truck, that goes from a to b.

Another example is e.g., where the shipment enters a wholesaler, where in this case, the subset of data may identify e.g. a number of items in a shipment or an type of product being in the shipment. Accordingly, the wholesaler may use the scanning to achieve information about how many items that are in the box, or what pharmaceutical product types etc.

Moreover, the information may now be presented in a language being meaningful for the wholesaler, that if the scanning occurs in Germany, the information flow would be result in information in German.

The location information may in an embodiment include the country code of scanning, or more detailed location information may be obtained e.g., via cellular triangulation so as to provide an exact location of the scanning device.

In an embodiment, the plurality of application identifiers includes one or more of: a serial number identifier, a Global Trade Item Number (GTIN) code, an expiry date identifier of the pharmaceutical product, a batch/lot number of the pharmaceutical product, a final destination identifier identifying a final destination of the pharmaceutical product. The umbrella for these identifiers is a so-called GS1 standard where the code may be in a barcode form or as a data matrix (QR code).

The term manufacturing URL may in one embodiment be understood as a specific URL that is intended to guide the person performing the scanning, e.g., an end-user, to a web portal to get further information on the pharmaceutical product. Thus, by adding a new application identifier identical to a so-called GS1 Resolver in digital link version, it is possible to use the information in the barcode or the QR code to guide the person to a web portal that is linked to said pharmaceutical product.

In an embodiment, when the location information of the scanning matches with the final destination identifier, the information flow includes showing an Electronic (E)-leaflet in a language matching the country code of the scanning. Accordingly, a tracking of the pharmaceutical product up to Point of Consumption (POS) is provided giving patients access to product data such as if the pharmaceutical product is safe to be consumed via e.g., stability budget information and thus the patient protection is ensured. Moreover, the pharmaceutical industry can be ensured that the POS is correct and thus a better protection against counterfeit and illegal parallel importing is provided.

Further, worldwide paper waste is avoided due to the E-leaflets where the E-leaflets is preferably in the end-user's language where the POI is.

In an embodiment, when the location information of the scanning matches with the final destination identifier, the information flow includes data indicating if the pharmaceutical product is safe for consumption. Accordingly, if e.g., IP address or the WiFi location data matches with target destination in the shipment order it is ensured that the consumer is the patient. This may e.g., be the case when the transport is direct to a patient, and e.g., not to a wholesaler. In this case, full access or a detailed information flow is triggered on the URL portal address showing e.g., detailed information about the stability budget during the transport throughout the supply chain and whether the pharmaceutical product is safe to be consumed.

In an embodiment, the unique ID is printed or attached to packaging material containing the pharmaceutical product.

In an embodiment, a wireless logger device having a unique logger ID code is associated with the pharmaceutical product by placing the wireless logger device into the packaging material (packaging unit) containing the pharmaceutical product, where the wireless logger device is configured to measure in real time an environmental related parameter such as temperature of the product and regularly transmit the measured environment related parameter together with the location information of the logger device to an external computer.

In an embodiment, the unique logger ID code is paired with the unique ID of the pharmaceutical product, where the paired ID's are transmitted to the external computer where it is stored.

The packaging material may be on a consumer packing level (e.g. a package with a single medicine), or box level packing (e.g. multiple consumer packages in a single box) as an example.

Accordingly, such a unique pairing between the logger device ID, e.g. the serial number of the wireless logger device, and the ID of the pharmaceutical product, a full tracking is provided down to the “unit level”.

As an example, when multiple of such packaging material are initially transported within the supply chain as a larger package, e.g. multiple packaging materials placed on a pallet, and where this larger package is later within the supply chain split into smaller packaging units in a (e.g. distribution centre) and down into the smallest unit level, a full tracking and visibility is obtained throughout the supply chain.

Due to the pairing of the wireless logger device ID and the unique ID of the pharmaceutical product, the external computer, via the received wireless logger device ID, contains the necessary data to link the received positional data for each individual wireless logger device to the characteristic information of the pharmaceutical product in the individual packaging. Thus, a full visibility of the pharmaceutical products in the packaging units is provided throughout the whole supply chain where multiple transport legs are present.

The term supply chain may as an example be understood as a transport from a manufacturing and/or the packaging side where the asset is manufactured and/or packed to a first destination which may be a first distribution centre, e.g. at a harbour (this may be understood as the primary transport), from the first destination to at least one second destination (e.g. one or more distribution centre(s)). This second one or more transport legs may be understood as the secondary transport. From there the shipment units (one or more together) are transported to a final destination, which may e.g. be hospital, pharmacy, patient etc. This last transport leg may be understood as the last mile transport.

The wireless logger device may according to the present invention be understood as an IoT label or “smart-label” where the power source may contain an ultra-thin flexible battery, e.g. a ZincPoly solid-state battery, where the thickness of the wireless logger device may be within the millimeter range.

The wireless logger device may also be referred to as a real time logger, or as a multi-use data logger, containing a re-chargeable battery, e.g. lithium-ion or dry cell battery, where the thickness of the logger device may be between 1-3 cm thick.

In an embodiment, the wireless logger device is further configured to measure, via at least one sensor comprised in the logger device, at least one environment related parameter while transporting the pharmaceutical product from the origin location to a destination location, wherein the method further comprises additionally transmitting the measured at least one environment related parameter together with the positional data and the wireless logger device ID to the external computer. Thus, additionally a real time tracking of the at least one environment related parameter while transporting the pharmaceutical product from the origin location to a destination location is provided. This could as an example include the temperature, and/or humidity, and/or light intensity, and/or acceleration/deceleration, and/or air pressure etc.

In another aspect of the invention, a system is provided for operating information flow for a product such as a pharmaceutical product while transporting the product in a supply chain from a primary transport leg to a last-mile transport leg, where the product has an associated unique identifier (ID), the system comprising:
a scanning device for scanning the unique ID of the product,
a locator provider for providing location information identifying a location where the scanning of the unique ID took place,
a computer device for accessing a manufacturing Uniform Resource Locator (URL) portal address related to the product via the scanned unique ID by the scanning device,
a rule engine configured to utilize the location information at the URL as input data in a process which defines a subset of data record related to the product and control the information flow by providing the subset of the data record via the URL portal address.

The locator provider may be configured to provide the location information such that it defines a location where the scanning device is located. This may efficiently automate the process an increase the security and may guarantee that the location is verified as a true location.

The rule engine may be configured to control the information flow on the URL portal address by utilizing the location information as input data in a process which defines a subset of a data record defining data related to the pharmaceutical product, and by providing the information flow of the subset of the data record via the URL portal address.

In an embodiment, the system further comprises a wireless logger device having a unique logger ID code, comprising:
at least one measuring device for measuring at least one environment related parameter of, or around the pharmaceutical product,
a memory of storing the at least one measured environmental related parameters,
a communication module for communicating with an external control computer including transmitting location related data of the wireless logger device together with the stored at least one stored environment related parameter, and
a processor for controlling the at least one measuring device, the memory, and the communication module,
wherein the unique logger ID code is paired with the unique ID of the pharmaceutical product, where the paired ID's are transmitted to an external computer where they are stored. Accordingly, tracking on a unit level is provided.

In an embodiment, the information flow includes temperature related data of the pharmaceutical product during transport in the supply chain from the primary transport leg to the last-mile transport leg.

In general, the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a flowchart of an embodiment of a method according to the present invention, and

FIG. 2 depict graphically an embodiment of utilizing the method shown in the flowchart in FIG. 1.

### DESCRIPTION OF EMBODIMENTS

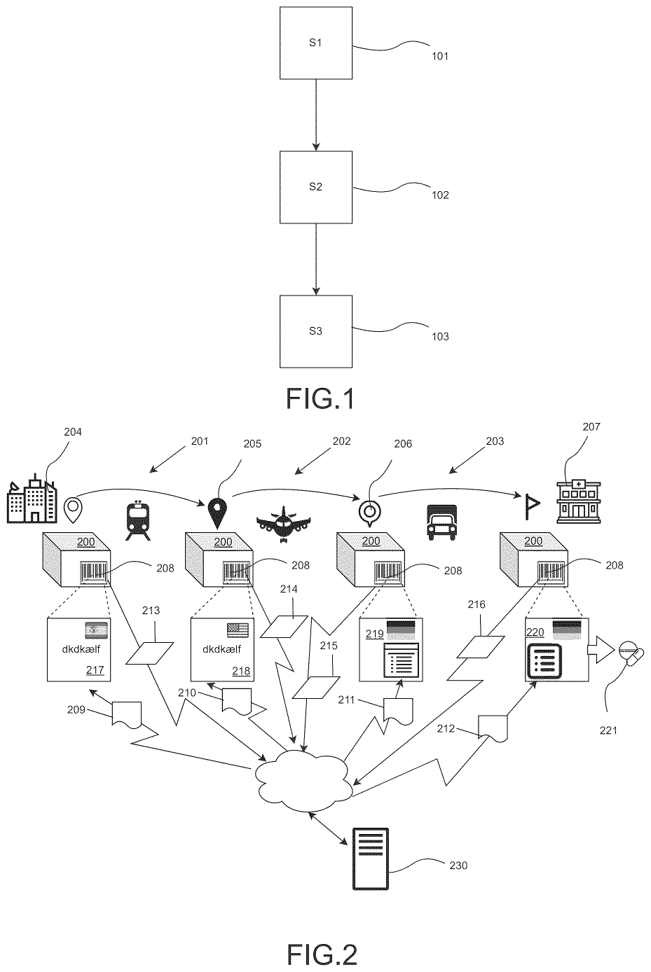

FIG. 1 shows a flowchart of an embodiment of a method according to the present invention, i.e. a method of operating information flow for a product, which in the following is assumed to be a pharmaceutical product, while transporting the pharmaceutical product in a supply chain from a primary transport leg to a last-mile transport leg, where the pharmaceutical product has an associated unique identifier (unique ID) containing a plurality of application identifiers identifying different characteristic data related to the pharmaceutical product.

In a first step (S1) 101, the unique ID of the pharmaceutical product is scanned, e.g., with a mobile phone or any portable device.

In a second step (S2) 102, location information where the scanning took place is provided where the location information is e.g., the country code of the scanning.

In a third step (S3) 103, a manufacturing Uniform Resource Locator (URL) portal address is accessed related to the pharmaceutical product via scanning the unique ID, wherein the location information is utilized as input data in controlling a information flow on the URL portal address.

FIG. 2 illustrates graphically a simplified example where a pharmaceutical product 200 is transported in a supply chain consisting of three transport legs 201-203, where the first transport leg 201 is a primary distribution and starts at a manufacturing (or packaging) site 204, the second transport leg 202 is secondary distribution and the last transport leg 203 is last mile distribution, where the primary and secondary distributions are e.g., separated at a regional distribution site 205, and the second and last mile distribution is separated at a local market distribution 206.

In this example, three scanning processes are depicted where location information 213-215 for the three different locations are transmitted to a central control computer 216, where a relatively accurate location information may be determined via e.g., a cellular triangulation, or via an IP address.

As discussed in relation to FIG. 1, the manufacturing Uniform Resource Locator (URL) portal address is accessed based upon the scanning, where the unique ID may be any type of a QR code such as GS1 code that uniquely identifies the pharmaceutical product. As mentioned above, this location is utilized as input data in controlling information flow on the URL portal address.

Assuming that the first scanning is performed in the primary distribution which may be Spain e.g., because the cellular network is Spanish, the information flow of the URL address 217, i.e. the information shown on the URL address in selected accordingly, namely in Spanish, and the amount of information 209 shown may be minimal, e.g., simple message asking the person doing the scanning to confirm that the visible condition of the package is ok.

This minimal amount of information is a subset of a more complete data record stored in the computer 230. The computer 230 uses the location information as input data in a process by which the subset, in this case the minimal amount of data related to the pharmaceutical product, is defined. The computer 230 thereby controls the information flow by providing the subset of the data record on via the URL portal address.

The next scanning location information 214 at another location in e.g., another country, e.g., USA, triggers the same minimal information 210 displayed 218 but this time, the message is in English.

The third scanning location information 215 at another location in e.g., another country, e.g., Germany, triggers higher amount of information 211 displayed 219 but this time the message is in Germany. This position may show that the pharmaceutical product is at a wholesaler that is provided with more information.

The fourth scanning location information 216, which may be at a hospital in Germany, triggers a maximum amount of information 212 being displayed 220.

The scanning may be done by any type of a scanning device such as a mobile phone or portable device.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

### LIST OF NUMBERED EMBODIMENTS

1. A method of operating information flow for a pharmaceutical product while transporting the pharmaceutical product in a supply chain from a primary transport leg to a last-mile transport leg, where the pharmaceutical product has associated unique identifier (ID) containing plurality of application identifiers identifying different characteristic data related to the pharmaceutical product, the method comprising:
scanning the unique ID of the pharmaceutical product,
providing location information of the scanning,
accessing a manufacturing Uniform Resource Locator (URL) portal address related to the pharmaceutical product via scanning the unique ID,
wherein the location information is utilized as input data in controlling information flow on the URL portal address.
2. The method according to embodiment 1, wherein the location information are provided via IP address of the scanning, and/or WiFi location information, and/or cellular network cells.
3. The according to embodiment 1, wherein controlling the information flow includes selecting the language of the information flow such that it matches the country code of the scanning.
4. The method according to any of the preceding embodiments, wherein controlling the information flow includes filtering the amount of content being shown on the URL address.
5. The method according to any of the preceding embodiments, wherein the plurality of application identifiers includes one or more of: serial number identifier, Global Trade Item Number (GTIN) code, expiry date identifier of the pharmaceutical product, batch/lot number of the pharmaceutical product, final destination identifier identifying final destination of the pharmaceutical product.
6. The method according to embodiment 5, wherein when the location information of the scanning match with the final destination identifier, the information flow includes showing Electronic (E)-leaflet in a langue of matching the country code of the scanning.
7. The method according to embodiment 5, wherein when the location information of the scanning match with the final destination identifier, the information flow includes data indicating if the pharmaceutical product is safe for consumption.
8. The method according to any of the preceding embodiments, wherein the unique ID where the unique ID is printed or attached to packaging material containing the pharmaceutical product.
9. The method according to any of the embodiments 1 to 8, wherein a wireless logger device having a unique logger ID code is associated with the pharmaceutical product configured to measure in real time environmental related parameters such as temperature.
10. The method according to embodiment 1, where the unique logger ID code is paired with the unique ID of the pharmaceutical product.
11. The method according to embodiment 9 or 10, wherein the unique ID of the pharmaceutical product attached to the wireless logger device.
12. A system for operating information flow for a pharmaceutical product while transporting the pharmaceutical product in a supply chain from a primary transport leg to a last-mile transport leg, where the pharmaceutical product has associated unique identifier (ID) containing plurality of application identifiers identifying different characteristic data related to the pharmaceutical product, the method comprising:
a scanning device for scanning the unique ID of the pharmaceutical product,
a locator provider for providing location information of the scanning,
a computer device for accessing a manufacturing Uniform Resource Locator (URL) portal address related to the pharmaceutical product via scanning the unique ID,
a rule engine configured to utilize the location information is utilized as input data in controlling information flow on the URL portal address.
13. The system according to embodiment 12, further comprising a wireless logger device having a unique logger ID code, comprising:
at temperature sensor for measuring temperature of or around the pharmaceutical product,
a memory of storing the measured environmental related parameters,
a communication module for communicating with an external control computer including transmitting location related data of the wireless logger device, and
a processor for controlling the at least one measuring device, the memory and the communication module,
wherein the unique logger ID code is paired with the unique ID of the pharmaceutical product.
14. The system according to embodiment 13, wherein the information flow includes temperature related data of the pharmaceutical product during transport in the supply chain from the primary transport leg to the last-mile transport leg.

1.-19. (canceled)

20. A method of controlling an information flow related to a product while transporting the product in a supply chain from a primary transport leg to a last-mile transport leg, where the product has an associated unique identifier (unique ID), the method comprising:
scanning the ID of the product by use of a scanning device,
providing location information identifying a location where the scanning of the unique ID took place,
accessing a manufacturing Uniform Resource Locator (URL) portal address related to the product for which the unique ID is scanned,
providing the location information to the URL and utilizing the location information at the URL as input data in a process which defines a subset of a data record related to the product, and
controlling the information flow by providing the subset of the data record via the URL portal address.

21. The method according to claim 20, wherein the product comprises a pharmaceutical product.

22. The method according to claim 20, wherein the location information is provided via an IP address of the scanning device, and/or a WiFi location information, and/or a cellular network cell.

23. The method according to claim 20, wherein the controlling of the information flow includes selecting the language of the information flow such that it matches the language associated to the country code of the scanning.

24. The method according to claim 20, wherein the controlling of the information flow includes filtering the amount of content related to the product being shown on the URL address.

25. The method according to claim 20, wherein the unique ID contains a plurality of application identifiers,
wherein each application identifier identifies characteristic data related to the product.

26. The method according to claim 25, wherein the plurality of application identifiers includes one or more of: a serial number identifier, a Global Trade Item Number (GTIN) code, an expiry date identifier of the product, a batch/lot number of the product, a final destination identifier identifying a final destination of the product.

27. The method according to claim 25, wherein each application identifier is different from the other application identifiers.

28. The method according to claim 20, wherein, when the location information of the scanning matches with the final destination identifier, the information flow includes showing an Electronic (E)-leaflet in a language matching the language associated to the country code of the scanning.

29. The method according to claim 20, wherein, when the location information of the scanning match with the final destination identifier, the information flow includes data indicating if the product is safe for consumption.

30. The method according to claim 20, where the unique ID is printed or attached to packaging material containing the product.

31. The method according to claim 30, wherein a wireless logger device having a unique logger ID code is associated with the product by placing the logger into the packaging material, where the wireless logger device is configured to measure in real time an environmental related parameter such as temperature of the product and regularly transmit the measured environment related parameter together with the location information of the logger device to an external computer where the paired data is stored.

32. The method according to claim 31, where the unique logger ID code is paired with the unique ID of the pharmaceutical product, where the paired ID's are transmitted to the external computer where it is stored.

33. The method according to claim 31, wherein the unique ID of the pharmaceutical product attached to the wireless logger device.

34. The method according to claim 20, wherein the location information is provided by the scanning device.

35. The method according to claim 20, wherein the URL is accessed by the scanning device when scanning the unique ID.

36. A system for operating information flow for a product such as a pharmaceutical product while transporting the product in a supply chain from a primary transport leg to a last-mile transport leg, where the product has an associated unique identifier (ID), the system comprising:
a scanning device for scanning the unique ID of the product,
a locator provider for providing location information identifying a location where the scanning of the unique ID took place,
a computer device for accessing a manufacturing Uniform Resource Locator (URL) portal address related to the product via the scanned unique ID by the scanning device,
a rule engine configured to utilize the location information at the URL as input data in a process which defines a subset of data record related to the product and control the information flow by providing the subset of the data record via the URL portal address.

37. The system according to claim 36, further comprising a wireless logger device having a unique logger ID code, the wireless logger device comprising:
at least one measuring device for measuring at least one environment related parameter of or around the pharmaceutical product,
a memory of storing the measured at least one environmental related parameter,
a communication module for communicating with an external control computer including transmitting location related data of the wireless logger device together with the stored at least one stored environment related parameter, and
a processor for controlling the at least one measuring device, the memory and the communication module,
wherein the unique logger ID code is paired with the unique ID of the pharmaceutical product, where the paired ID's are transmitted to an external computer where they are stored.

38. The system according to claim 37, wherein the at least one measuring device comprises a temperature sensor for measuring the temperature of the product, where the information flow includes temperature-related data of the product during transport in the supply chain from the primary transport leg to the last-mile transport leg.
